(19) United States
(12) Patent Application Publication
(10) Pub. No.: US 2015/0304239 A1
(43) Pub. Date: Oct. 22, 2015

(54) TELECOMMUNICATION NETWORK NODE SUPPORTING HYBRID MANAGEMENT USING A HARDWARE ABSTRACTION AND MANAGEMENT PROTOCOL CROSS-CONNECT FUNCTION

(71) Applicant: OLIVER SOLUTIONS LTD., Herzliya (IL)

(72) Inventor: Toshihiko Kusano, Kanagawa (JP)

(21) Appl. No.: 14/435,746

(22) PCT Filed: Nov. 14, 2013
(86) PCT No.: PCT/IL13/50947

§ 371 Date: Apr. 15, 2015

Related U.S. Application Data
(60) Provisional application No. 61/730,061, filed on Nov. 27, 2012.

(51) Int. Cl. H04L 12/911; G06F 9/54

(52) U.S. Cl. CPC H04L 47/783; G06F 9/547

(57) ABSTRACT

A telecommunication node within a network of nodes managed by more than one network manager, including a plurality of management interfaces, each management interface operative to communicate with a different network manager using a respective protocol, wherein at least two of the protocols are different protocols, a plurality of hardware resources, each resource being accessed through a respective application programming interface (API), and a cross-connect module, coupled with the management interfaces and with the hardware resources, operative to make each management interface interoperable with all of the APIs.

### CROSS REFERENCE TO RELATED APPLICATIONS

This application claims convention priority benefit of U.S. Provisional Application No. 61/730,061, entitled TELECOMMUNICATION NETWORK NODE SUPPORTING HYBRID MANAGEMENT USING A HARDWARE ABSTRACTION AND MANAGEMENT PROTOCOL CROSS-CONNECT FUNCTION, filed on Nov. 27, 2012 by inventor Toshihiko Kusano.

### FIELD OF THE INVENTION

The present invention relates to access telecommunication networks.

### BACKGROUND OF THE INVENTION

Recently, software defined networking (SDN) has been recognized as a next generation network management system for packetized data communication. SDN includes a control plane, i.e., a system that makes decisions about where traffic is sent, and a data plane, i.e., a system that forwards traffic to its destination. Network devices reside in the data plane, and interface with the control plane through a control plane/data plane interface. SDN manages network devices through abstraction of lower level functionality by decoupling the control plane from the data plane. SDN enables network administrators to have programmable central control of network traffic without requiring physical access to the network's switches. SDN creates a logical network control plane where a network switch can forward packets and a separate server can run the network control plane. The decoupling allows for the control plane to be implemented using a different distribution model than the data plane.

Telecommunication operators are interested in adopting SDN, and the Open Networking Foundation (ONF) has standardized a protocol, OPENFLOW™, for communication between the control plane and the data plane. During the upgrade from existing management systems to SDN-based management systems, both management systems will co-exist.

Conventional telecommunication network nodes are configured to work with a designated management system using a designated protocol. As such, upgrading an existing management system with an SDN-based management system requires replacement of all deployed telecommunication nodes with nodes adapted to the SDN-based management system; i.e., replacement of an entire network. Such replacement is enormously expensive and time-consuming, and causes disruption of service. For access network systems, the upgrade requires replacement of entire customer premises equipment (CPE).

One approach to upgrading management systems is to introduce an external protocol convertor between a new management system and the telecommunication network nodes that operate within an existing management system. However, this approach does not work well, since each management protocol is related to a different distribution model, and telecommunication network nodes that operate in accordance with one distribution model may exhibit anomalous behavior if they are managed in accordance with another distribution model.

Thus it would be of advantage to find an efficient way to operate existing telecommunication network nodes in accordance with a new management system.

### SUMMARY OF THE DESCRIPTION

Embodiments of the present invention provide efficient ways to operate telecommunication network nodes in accordance with a hybrid management environment, by introducing a cross-connect module within the nodes. Aspects of the present invention enable telecommunication network nodes to interoperate with an existing management protocol and with other protocols, including inter alia a control plane/data plane interface for supporting SDN.

The cross-connect module of the present invention connects a hardware abstraction with a management protocol. The hardware abstraction generalizes the properties of a telecommunication network node's hardware resource application programming interface (API). The cross-connect module converts each management protocol to an API of a destination hardware resource, based on a pre-designated conversion rule.

Since the cross-connect module of the present invention is internal to a telecommunication network node, at the hardware resource application interface level, affinity among different management protocols is high vis-à-vis an external protocol convertor.

The present invention is of particular advantage for access networks, by enabling continuous use of CPEs while upgrading a management system. Otherwise, without the present invention, operators would need to replace CPE's located at customer sites, which is a major undertaking and which entails disruption of service. In distinction, the present invention enables operators to upgrade a management system seamlessly, without having to upgrade CPEs.

There is thus provided in accordance with an embodiment of the present invention a telecommunication node within a network of nodes managed by more than one network manager, including a plurality of management interfaces, each management interface operative to communicate with a different network manager using a respective protocol, wherein at least two of the protocols are different protocols, a plurality of hardware resources, each resource being accessed through a respective application programming interface (API), and a cross-connect module, coupled with the management interfaces and with the hardware resources, operative to make each management interface interoperable with all of the APIs.

There is additionally provided in accordance with an embodiment of the present invention a method for managing a telecommunication node within a network of nodes managed by a network manager, including monitoring a control instruction received from a source one of a plurality of management interfaces, each management interface using a different protocol, the control instruction intended for controlling a destination hardware resource from among a plurality of hardware resources, each hardware resource being accessed through a respective application programming interface (API), converting the control instruction so as to conform with the API of the destination hardware resource, saving relationship information for the control instruction, the protocol of the source management interface, and the API of the destination resource, and forwarding the converted control instruction to the API of the destination hardware resource.

There is further provided in accordance with an embodiment of the present invention a method for managing a telecommunication node within a network of nodes managed by a network manager, including monitoring a control instruction received from a source one of a plurality of management interfaces, each management interface using a different protocol, the control instruction intended for controlling a destination hardware resource from among a plurality of hardware resources, each hardware resource being accessed through a respective application programming interface (API), when the source management interface uses a standard management protocol and the destination hardware resource uses a standard API, forwarding the control instruction to the API of the destination hardware resource without conversion, and when the source management interface uses a non-standard management protocol or the destination hardware resource uses a non-standard API: converting the control instruction so as to conform with the API of the destination hardware resource, saving relationship information for the control instruction, the protocol of the source management interface, and the API of the destination resource, and forwarding the converted control instruction to the API of the destination hardware resource.

There is yet further provided in accordance with an embodiment of the present invention a method for managing a telecommunication node within an access network of central offices and customer premises equipment, including monitoring a control instruction received from a source one of a plurality of management interfaces, each management interface using a different protocol, the control instruction intended for controlling a destination one of at least one customer premises equipment (CPE), each CPE being controlled by a central office via a dedicated bi-directional data link, when the control instruction is received from a management interface that uses a standard protocol, forwarding the control instruction to the destination CPE without conversion, and when the control instruction is received from a management interface that does not use a standard protocol: converting the control instruction so as to conform with a protocol of the data link between the central office and the destination CPE, saving relationship information for the control instruction, the protocol of the source management interface, and the destination CPE, requesting a logical bi-directional CPE management tunnel to carry the converted control instruction, and forwarding the control instruction in the tunnel for further transmission to the destination CPE.

### BRIEF DESCRIPTION OF THE DRAWINGS

The present invention will be more fully understood and appreciated from the following detailed description, taken in conjunction with the drawings in which:

FIG. 1 is a simplified block diagram of a telecommunication network with hybrid management, in accordance with an embodiment of the present invention;

FIG. 2 is a simplified block diagram of a cross-connect module within a telecommunication node for a general communication network that connects two management interfaces with two hardware resources, in accordance with an embodiment of the present invention;

FIG. 3 is a simplified flowchart of a method performed by the cross-connect module of FIG. 2, for converting a control instruction received from a management interface so as to conform with an application programming interface (API) of a destination hardware resource, in accordance with an embodiment of the present invention;

FIG. 4 is a simplified flowchart of a method performed by the cross-connect module of FIG. 2, for converting a reply message received from a hardware resource so as to conform with a protocol of a destination management interface, in accordance with an embodiment of the present invention;

FIG. 5 is a simplified block diagram of a cross-connect module within a telecommunication node for a general communication network that connects each of two management interfaces, one using a standard protocol and the other using a non-standard protocol, with two hardware resources, in accordance with an embodiment of the present invention;

FIG. 6 is a simplified flowchart of a method performed by the cross-connect module of FIG. 5, for converting a control instruction received from a management interface so as to conform with an API of a destination hardware resource, in accordance with an embodiment of the present invention;

FIG. 7 is a simplified flowchart of a method performed by the cross-connect module of FIG. 5, for converting a reply message received from a hardware resource so as to conform with a protocol of a destination management interface, in accordance with an embodiment of the present invention;

FIG. 8 is a simplified block diagram of an access network with hybrid management of central office and customer premises equipment, in accordance with an embodiment of the present invention;

FIG. 9 is a simplified block diagram of a cross-connect module within a telecommunication node of an access network that includes a central office and customer premises equipment (CPE), the cross-connect module connecting each of two management systems, one using a standard protocol and the other using a non-standard protocol, with hardware resources of the central office and the CPE, in accordance with an embodiment of the present invention;

FIG. 10 is a simplified flowchart of a method performed by the cross-connect module of FIG. 9, for converting a control instruction received from a management interface so as to conform with a destination CPE, in accordance with an embodiment of the present invention; and

FIG. 11 is a simplified flowchart of a method performed by the cross-connect module of FIG. 9, for converting a reply message received from a CPE so as to conform with a protocol of a destination management interface, in accordance with an embodiment of the present invention.

### DETAILED DESCRIPTION

Aspects of the present invention relate to communication networks of nodes that are under control of two different management systems. In one embodiment, the nodes are central office equipment that control customer premises equipment (CPE). The present invention is of particular advantage for upgrading existing systems to SDN-based systems, since it obviates the need to replace an entire existing physical infrastructure of CPEs.

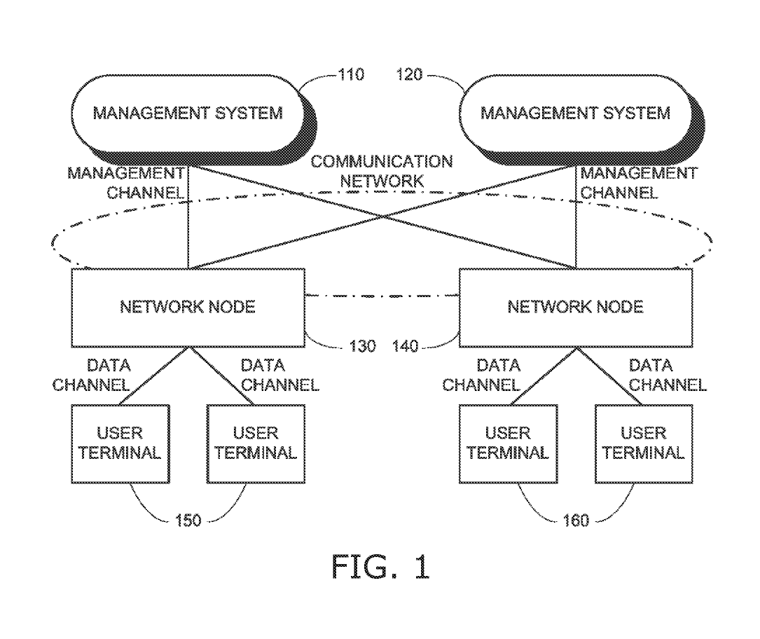

Reference is made to FIG. 1, which is a simplified block diagram of a telecommunication network with hybrid management, in accordance with an embodiment of the present invention. Shown in FIG. 1 are management systems 110 and 120 for managing a communication network of telecommunication nodes, including inter alia nodes 130 and 140. Node 130 connects with user terminals 150 via data channels, and node 140 connects with user terminals 160 via data channels.

Each of management systems 110 and 120 administers and operates the communication network by establishing data channels, configuring data forwarding rules, and performing other operations. Management system 110 may be, for example, an existing management system, and management system 120 may be an SDN-based management system.

It will be appreciated by those skilled in the art that the architecture shown in FIG. 1 is an exemplary architecture and, in practice, the present invention applies to differently configured architectures, including inter alia architectures having different numbers of management systems, nodes, hardware resources and user terminals.

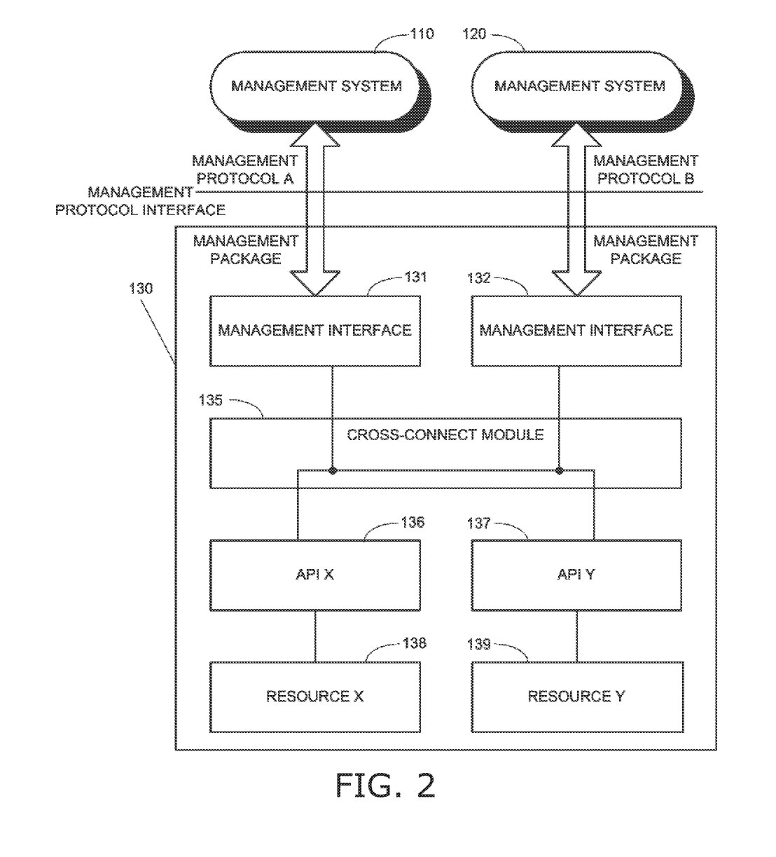

Reference is made to FIG. 2, which is a simplified block diagram of a cross-connect module within telecommunication node 130 of FIG. 1 for a general communication network that connects two management interfaces with two hardware resources, in accordance with an embodiment of the present invention. Telecommunication node 130 communicates with the two management systems 110 and 120. Telecommunication node 130 communicates with each management system 110 and 120 using a respective management interface 131 and 132. Communication is conducted via management packages that use respective protocols A and B in accordance with respective management systems 110 and 120.

Also shown in FIG. 2 are hardware resources X 138 and Y 139, which are accessed by respective application programming interfaces (APIs) X 136 and Y 137.

A cross-connect module 135 operates as a hardware resource abstraction and management protocol cross-connect, situated between management interfaces 131 and 132, and hardware APIs 136 and 137. In a conventional network node, which is managed by a single management system, a management package passes directly to a hardware resource's API to control the hardware resource. In distinction, cross-connect module 135 abstracts hardware resources X and Y, and uses a unified API that is a superset of APIs X and Y.

Each of management interfaces 131 and 132 can interact with both hardware resources X and Y through the unified API of cross-connect module 135, obviating the need to discriminate between the hardware resources. Cross-connect module 135 identifies a correlation between the unified API and a requested API, and performs a protocol conversion based on conversion rules stored in module 135.

The conversion performed by cross-connect module 135 may be a one-to-many conversion, and may involve adding controls and changing parameters and values as necessary. Cross-connect module 135 performs the following source/target conversions

protocol A to/from API X,

protocol A to/from API Y,

protocol B to/from API X, and

protocol B to/from API Y.

It will be appreciated by those skilled in the art that the architecture shown in FIG. 2 is an exemplary architecture and, in practice, the present invention applies to differently configured architectures, including inter alia architectures having different numbers of management systems, nodes, hardware resources and user terminals.

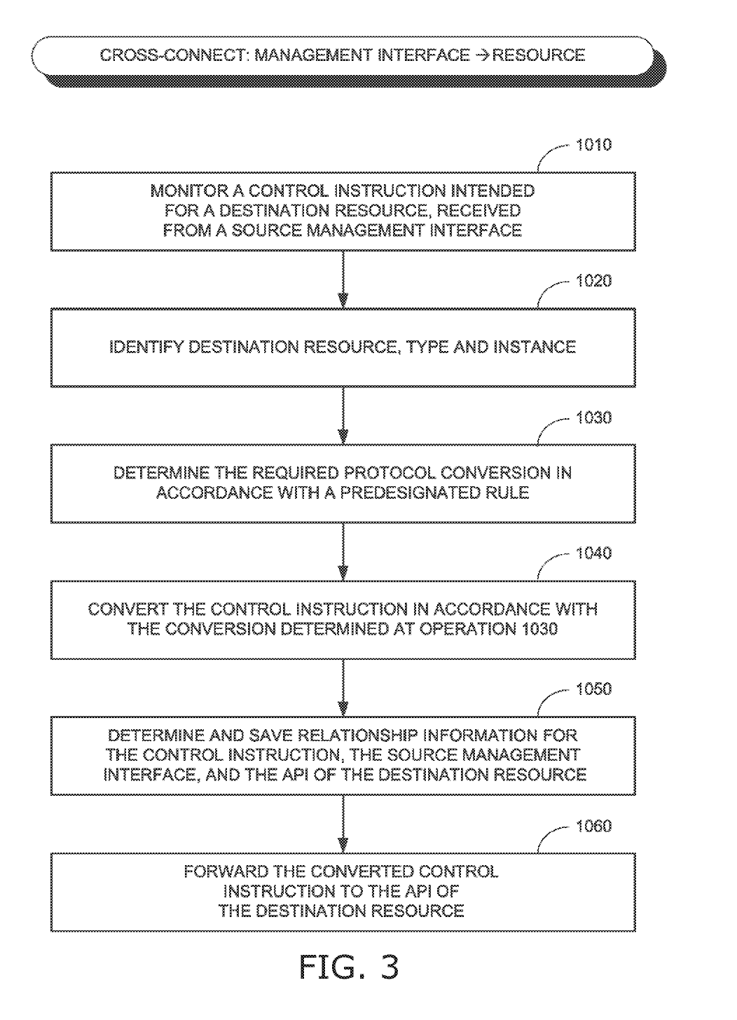

Reference is made to FIG. 3, which is a simplified flowchart of a method performed by cross-connect module 135 of FIG. 2, for converting a control instruction received from a management interface so as to conform with an API of a destination hardware resource, in accordance with an embodiment of the present invention. At operation 1010, the cross-connect module monitors a control instruction intended for a destination hardware resource, within a management packet received from a source management interface. At operation 1020 the cross-connect module identifies the destination hardware resource. Operation 1020 may be performed by parsing a protocol header or such other embedding mechanism, for destination information such as a physical port number and a card type ID.

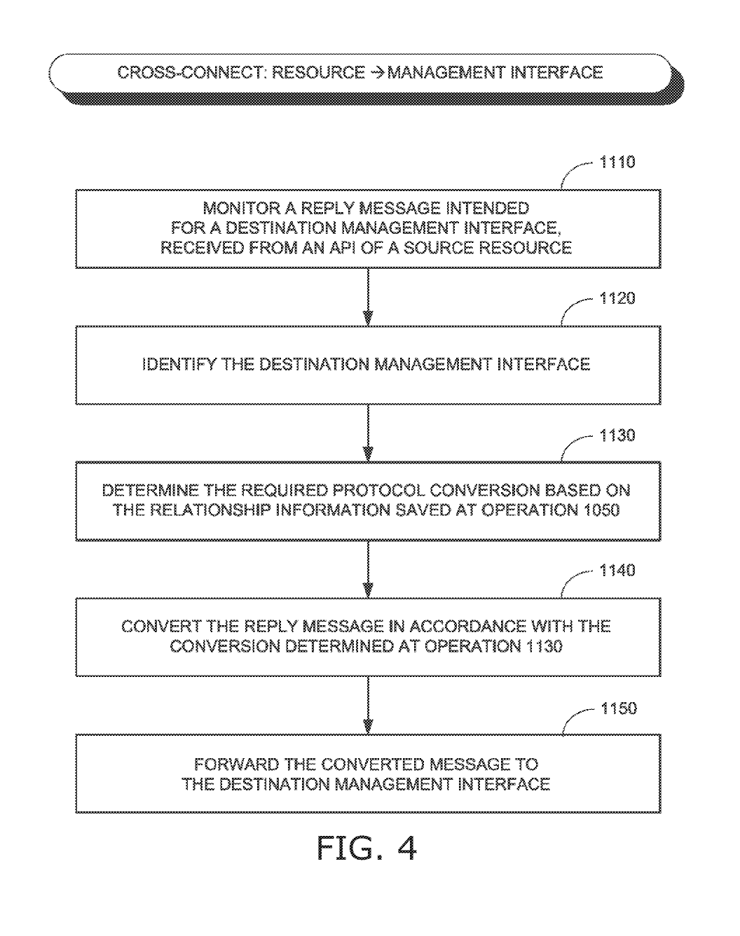

At operation 1030 the cross-connect module determines the conversion required from the source management package protocol in order to comply with the API of the destination hardware resource, based on a pre-designated rule. At operation 1040 the cross-connect module converts the control instruction using the thus-determined conversion. At operation 1050 the cross-connect module determines and saves relationship information for the control instruction, the source management interface, and the API of the destination hardware resource. Operation 1050 is performed in order for the cross-connect module to use the saved relationship information at operation 1130 of FIG. 4, when a reply message is returned from the API of the destination hardware resource, acting as source for the return path, to the source management interface, acting as destination for the return path. Use of the saved relationship information enables the cross-connect module to efficiently perform the required conversion for the reply message on the return path. At operation 1060 the cross-connect module forwards the thus-converted control instruction to the API of the destination hardware resource.

Reference is made to FIG. 4, which is a simplified flowchart of a method performed by cross-connect module 135 of FIG. 2, for converting a reply message received from a hardware resource API so as to conform with a protocol of a destination management interface, in accordance with an embodiment of the present invention. At operation 1110 the cross-connect module monitors a reply message intended for a destination management interface, received from a hardware resource API. At operation 1120 the cross-connect module identifies the destination management interface.

At operation 1130 the cross-connect module accesses the relationship information saved at operation 1050 of FIG. 3, and uses the relationship information to determine the conversion required from the source hardware resource API in order to comply with the destination management protocol. At operation 1140 the cross-connect module converts the reply message using the thus-determined conversion. At operation 1150 the cross-connect module forwards the thus-converted reply message to the destination management interface.

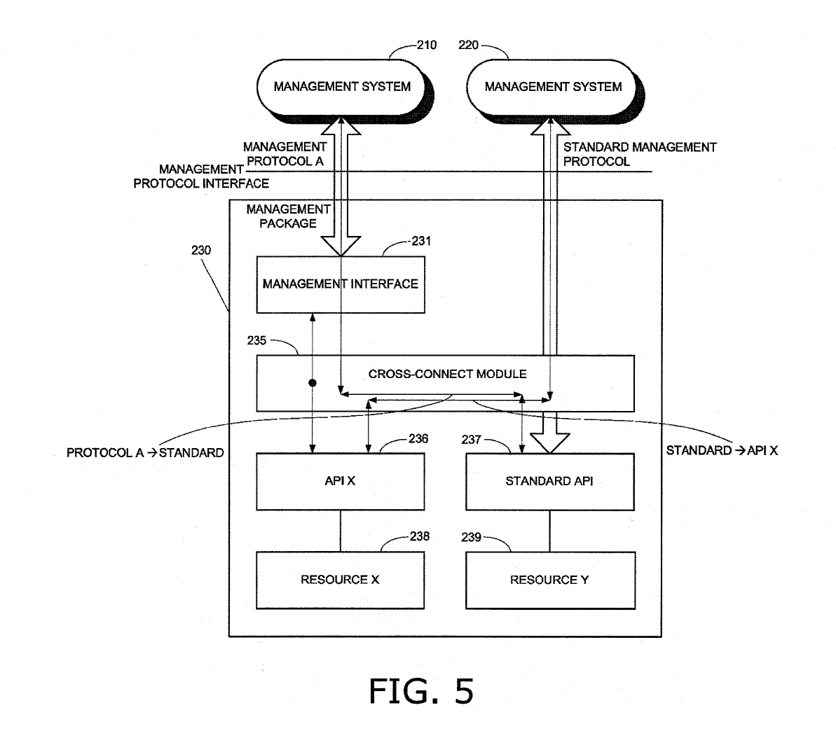

Reference is made to FIG. 5, which is a simplified block diagram of a cross-connect module 235 within a telecommunication node 230 for a general communication network that connects each of two management interfaces, one using a standard protocol and the other using a non-standard protocol, with two hardware resources, in accordance with an embodiment of the present invention. Telecommunication node 230 communicates with two management systems, 210 and 220. Management system 220 uses a standard resource management protocol, such as OPEN FLOW™. Telecommunication node 230 communicates with management system 210 using a management interface 231.

Also shown in FIG. 5 are hardware resources X 238 and Y 239. Hardware resource X is accessed by a hardware API X 236. Hardware resource Y is accessed by a standard API 237.

Cross-connect module 235 operates as a hardware resource abstraction and management protocol cross-connect, situated between management interface 231, and hardware APIs 236 and 237. Cross-connect module 235 abstracts hardware resources X and Y, and uses a unified API that is a superset of API X and standard API 237.

Communication with management system 210 is conducted via management interface 231 using a specific protocol A. Management system 220 connects directly with standard API 237.

Management interface 231 can interact with both hardware resources X and Y through the unified API of cross-connect module 235, obviating the need to discriminate between the hardware resources. Cross-connect module 235 identifies a correlation between the unified application interface and a requested application interface, and performs a protocol conversion based on conversion rules stored in module 235.

It will be appreciated by those skilled in the art that the architecture shown in FIG. 5 is an exemplary architecture and, in practice, the present invention applies to differently configured architectures, including inter alia architectures having different numbers of management systems, nodes, hardware resources and user terminals.

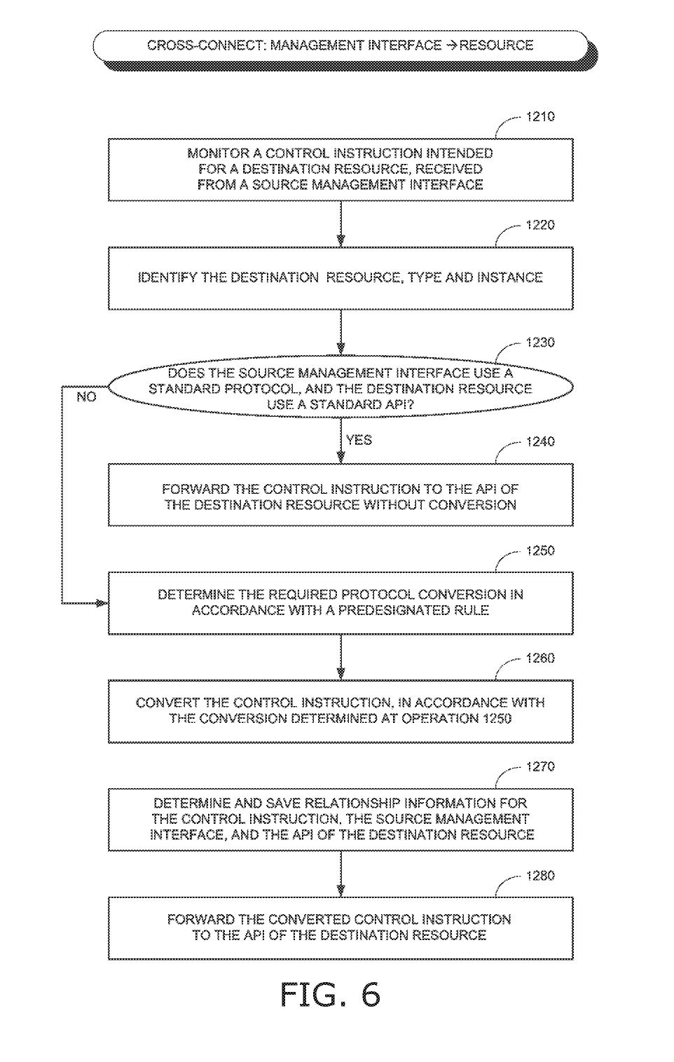

Reference is made to FIG. 6, which is a simplified flowchart of a method performed by cross-connect module 235 of FIG. 5, for converting a control instruction received from a management interface so as to conform with an API of a destination hardware resource, in accordance with an embodiment of the present invention. At operation 1210, the cross-connect module monitors a control instruction intended for the API of a destination hardware resource, received from a source management interface. At operation 1220, the cross-connect module identifies the destination hardware resource. Operation 1220 may be performed by parsing a protocol header or such other embedding mechanism, for destination information such as a physical port number and a card type ID.

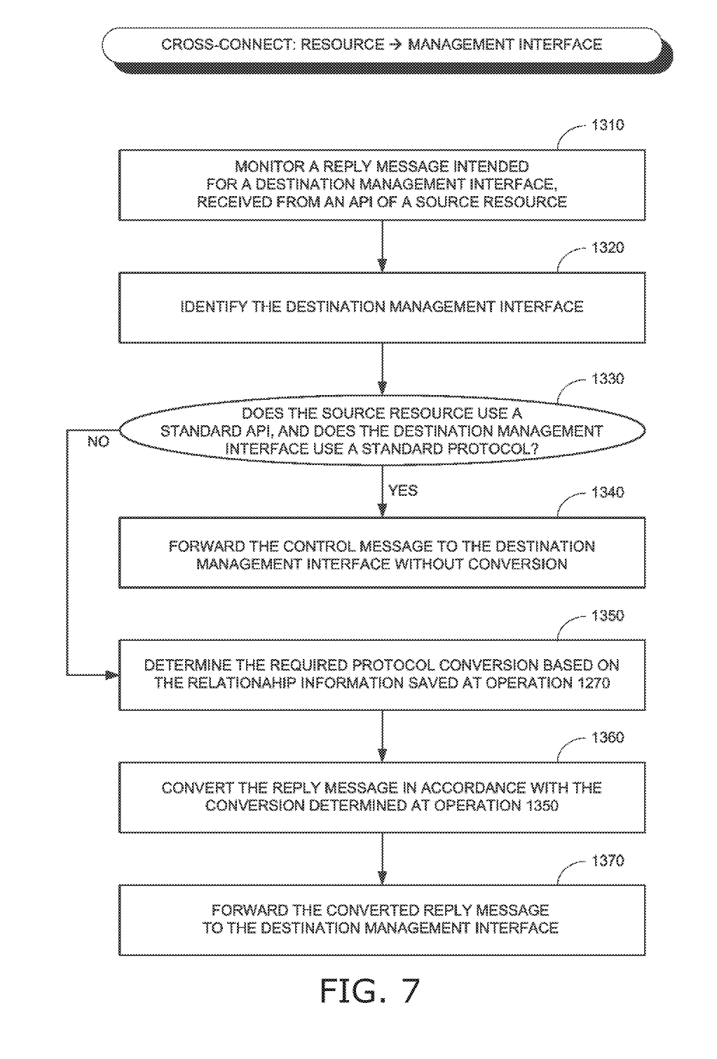

As shown at operation 1230, if the source management interface uses a standard protocol and the destination hardware resource uses a standard API, then the cross-connect module forwards the control instruction to the API of the destination hardware resource without conversion, at operation 1240. Otherwise, at operation 1250 the cross-connect module determines the conversion required from the source management package protocol in order to comply with the destination hardware API, based on a pre-designated rule. At operation 1260 the cross-connect module converts the control instruction using the thus-determined conversion. At operation 1270 the cross-connect module determines and saves relationship information for the control instruction, the source management interface, and the API of the destination hardware resource, for use in converting a reply message on the return path at operation 1350 of FIG. 7. At operation 1280 the cross-connect module forwards the thus-converted control instruction to the API of the destination hardware resource.

The conversion performed at operation 1260 may be a one-to-many conversion, and may involve adding controls and changing parameters and values as necessary.

Reference is made to FIG. 7, which is a simplified flowchart of a method performed by cross-connect module 235 of FIG. 5, for converting a reply message received from a hardware API so as to conform with a protocol of a destination management interface, in accordance with an embodiment of the present invention. At operation 1310, the cross-connect module monitors a reply message intended for a destination management interface, received from the API of a source hardware resource. At operation 1320, the cross-connect module identifies the destination management interface.

As shown at operation 1330, if the source hardware resource uses a standard API, and the destination management interface uses a standard protocol, then the cross-connect module forwards the reply message to the destination management interface without conversion, at operation 1340. Otherwise, at operation 1350 the cross-connect module accesses the relationship information saved at operation 1270 of FIG. 6, and uses the relationship information to determine the conversion required from the API of the source hardware resource in order to comply with the protocol of the destination management interface. At operation 1360 the cross-connect module converts the reply message using the thus-determined conversion. At operation 1370 the cross-connect module forwards the thus-converted reply message to the destination management interface.

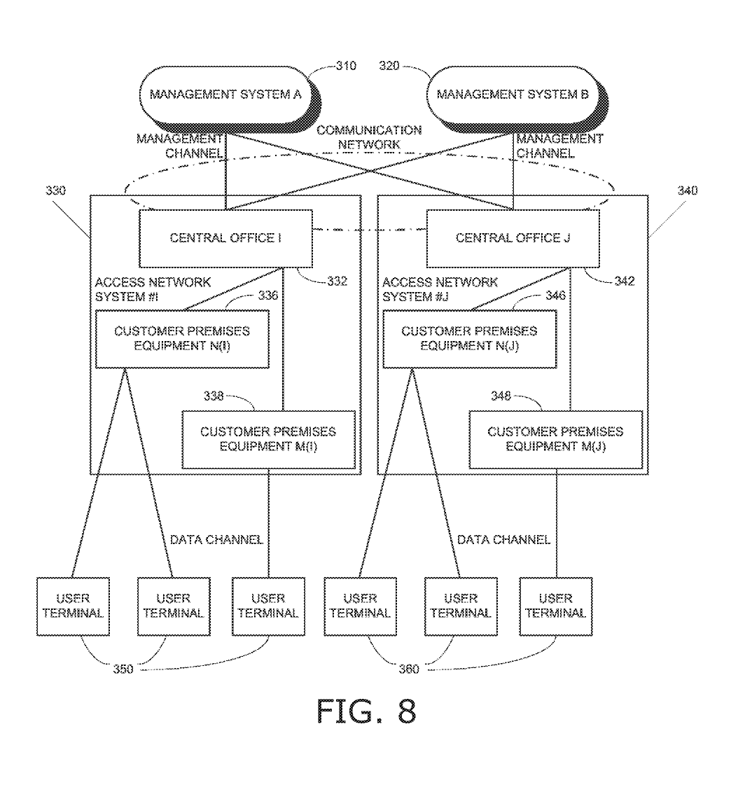

Reference is made to FIG. 8, which is a simplified block diagram of an access network with hybrid management of central office and customer premises equipment, in accordance with an embodiment of the present invention. Shown in FIG. 8 are management systems 310 and 320 for managing a communication network of central offices, including inter alia central offices 330 and 340. Central office 330 controls CPEs 336 and 338. CPEs 336 and 338 connect with user terminals 350 via data channels. Similarly, central office 340 controls CPEs 346 and 348, and CPEs 346 and 348 connect with user terminals 360 via data channels. Central offices 330 and 340 of the access network of FIG. 8 correspond to nodes 130 and 140 of the communications network of FIG. 1.

Each of management systems 310 and 320 administers and operates the access network by establishing data channels, configuring data forwarding rules, and performing other operations. One or both of management systems 310 and 320 may be, for example, an SDN-based management system.

It will be appreciated by those skilled in the art that the architecture shown in FIG. 8 is an exemplary architecture and, in practice, the present invention applies to differently configured architectures, including inter alia architectures having different numbers of management systems, central offices, CPEs and user terminals.

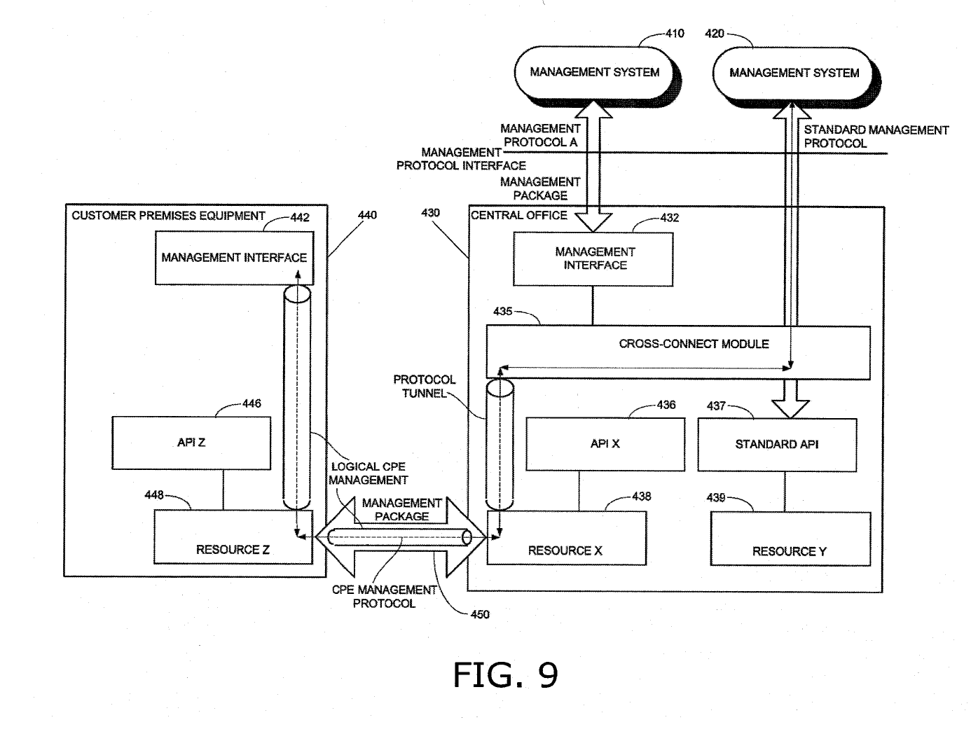

Reference is made to FIG. 9, which is a simplified block diagram of a cross-connect module 435 within a node of an access network that includes a central office 430 and a CPE 442, the cross-connect module adapting to each of two management systems, a management system 420 using a standard protocol and a management system 410 using a non-standard protocol A, with hardware resources 438 and 439 of the central office and with hardware a resource 440 of the CPE, in accordance with an embodiment of the present invention.

A dedicated bidirectional data link 450 transmits a management package from central office 430 to CPE 440. The transmission is performed through a logical CPE management protocol tunnel, which may be a collection of dedicated control channels, that is created between management packages in central office 430 and CPE 440. The tunnel enables function calls, inter process software communication, and a dedicated control channel over the data link in the physical layer. CPE 440 receives control instructions via the tunnel, parses the instruction, and then calls a hardware API Z 446 to operate a hardware resource Z 448.

As such, the same central office 430 is able to control a CPE through a standard resource API and to control a CPE through a non-standard resource API.

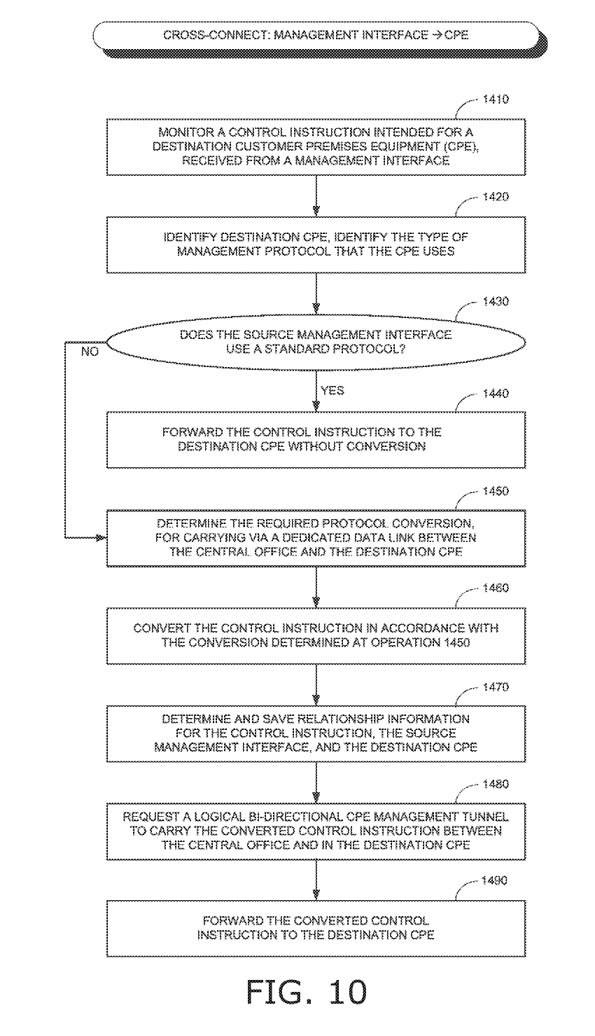

Reference is made to FIG. 10, which is a simplified flowchart of a method performed by the cross-connect module 435 of FIG. 9, for converting a control instruction received from a source management interface so as to conform to a destination CPE, in accordance with an embodiment of the present invention. At operation 1410 the cross-connect module monitors a control instruction intended for a destination hardware resource, received from a management interface. At operation 1420 the cross-connect module identifies a destination CPE that accesses the destination hardware resource, and identifies the management protocol that the thus-identified CPE uses.

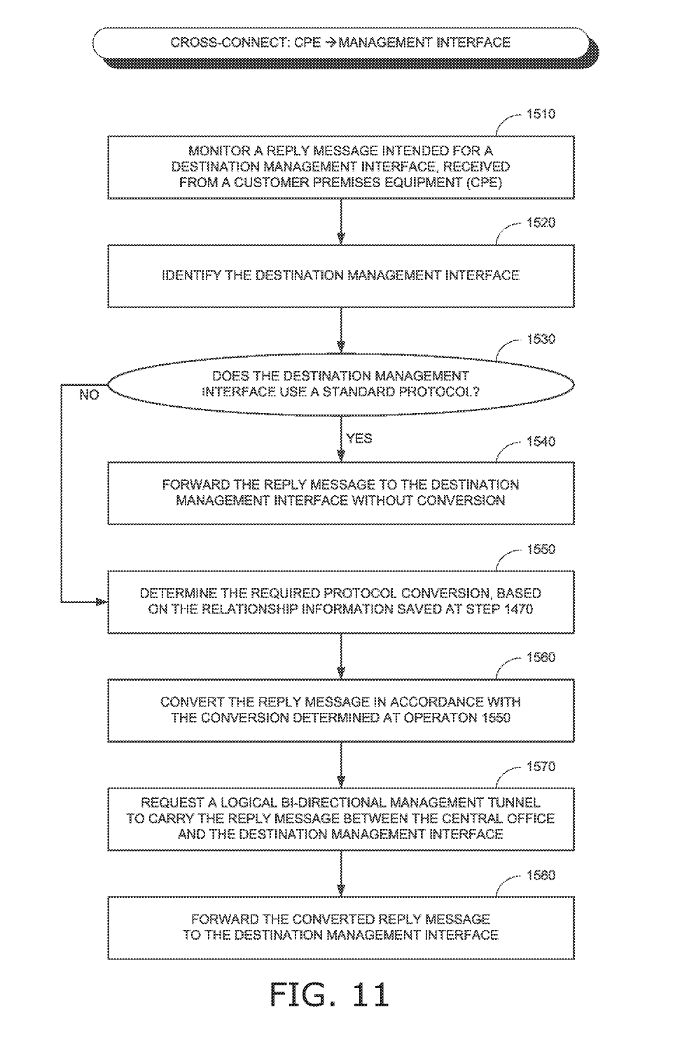

As shown at operation 1430, if the source management interface uses a standard protocol, then the cross-connect module forwards the control instruction to the destination CPE without conversion, at operation 1440. Otherwise, at operation 1450 the cross-connect module determines the required protocol conversion from the source protocol to the destination protocol, for carrying via a dedicated link between the central office that controls the CPE and the destination CPE. At operation 1460 the cross-connect module converts the control instruction in accordance with the CPE management protocol that exists inside the dedicated data link. At operation 1470 the cross-connect module determines and saves relationship information for the control instruction, the source management interface, and the destination CPE, for use in converting a reply message on the return path at operation 1550 of FIG. 11.

At operation 1480 the cross-connect module requests a logical bi-directional CPE management protocol tunnel to carry the converted control instruction between management packages in the central office and the destination CPE. At operation 1490 the cross-connect module forwards the converted control instruction to the central office, for further transmission to the destination CPE.

Reference is made to FIG. 11, which is a simplified flowchart of a method performed by cross-connect module 435 of FIG. 9, for converting a reply message received from a source CPE so as to conform to a protocol of a destination management interface, in accordance with an embodiment of the present invention. At operation 1510 the cross-connect module monitors a reply message intended for a destination management interface, received from a CPE. At operation 1520 the cross-connect module identifies the destination management interface.

As shown at operation 1530, if the destination management interface uses a standard protocol, then the cross-connect module forwards the control instruction to the destination management interface without conversion, at operation 1540. Otherwise, at operation 1550 the cross-connect module accesses the relationship information saved at operation 1470 of FIG. 10, and uses the relationship information to determine the required protocol conversion from the source protocol to the destination protocol. At operation 1560 the cross-connect module converts the reply message using the thus-determined conversion.

At operation 1570 the cross-connect module requests a logical bi-directional CPE management protocol tunnel to carry the converted reply message between management packages in the destination CPE and the central office. At operation 1580 the cross-connect module forwards the converted reply message to the central office for further transmission to the destination management interface.

Having read the above description, it will be appreciated by those skilled in the art that the present invention enables telecommunication operators to implement flexible management system and network device upgrade strategies in accordance with their business models.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

1. A telecommunication node within a network of nodes managed by more than one network manager, comprising:
a plurality of management interfaces, each management interface operative to communicate with a different network manager using a respective protocol, wherein at least two of the protocols are different protocols;
a plurality of hardware resources, each resource being accessed through a respective application programming interface (API); and
a cross-connect module, coupled with said management interfaces and with said hardware resources, operative to make each management interface interoperable with all of the APIs.

2. The telecommunication node of claim 1, wherein said cross-connect module supports an abstraction of all of the APIs.

3. The telecommunication node of claim 1, wherein at least one of said management interfaces uses a standard protocol that interoperates with all of the APIs.

4. The telecommunication node of claim 1, wherein at least one of the APIs is a standard API that interoperates with all of said management interfaces.

5. The telecommunication node of claim 1, further comprising:
a central office; and
at least one customer premises equipment (CPE) controlled by said central office; and
at least one dedicated bi-directional data link, connecting each respective at least one CPE with said central office.

6. A method for managing a telecommunication node within a network of nodes managed by a network manager, comprising:
monitoring a control instruction received from a source one of a plurality of management interfaces, each management interface using a different protocol, the control instruction intended for controlling a destination hardware resource from among a plurality of hardware resources, each hardware resource being accessed through a respective application programming interface (API);
converting the control instruction so as to conform with the API of the destination hardware resource;
saving relationship information for the control instruction, the protocol of the source management interface, and the API of the destination resource; and
forwarding the converted control instruction to the API of the destination hardware resource.

7. The method of claim 6, further comprising:
monitoring a reply message received from the API of one of the plurality of hardware resources in response to a specific control instruction, the reply message intended for a destination management interface;
converting the reply message so as to conform with the protocol of the destination management interface, using the saved relationship information for the specific control instruction; and
forwarding the converted reply message to the destination management interface.

8. A method for managing a telecommunication node within a network of nodes managed by a network manager, comprising:
monitoring a control instruction received from a source one of a plurality of management interfaces, each management interface using a different protocol, the control instruction intended for controlling a destination hardware resource from among a plurality of hardware resources, each hardware resource being accessed through a respective application programming interface (API);
when the source management interface uses a standard management protocol and the destination hardware resource uses a standard API, forwarding the control instruction to the API of the destination hardware resource without conversion; and
when the source management interface uses a non-standard management protocol or the destination hardware resource uses a non-standard API:
converting the control instruction so as to conform with the API of the destination hardware resource;
saving relationship information for the control instruction, the protocol of the source management interface, and the API of the destination resource; and
forwarding the converted control instruction to the API of the destination hardware resource.

9. The method of claim 8, further comprising:
monitoring a reply message received from an API of a source one of the hardware resources in response to a specific control instruction, the reply message intended for a destination management interface;
when the source hardware resource uses a standard API and the destination management interface uses a standard protocol, forwarding the reply message to the destination management interface without conversion; and
when the source hardware resource uses a non-standard API or when the destination management interface uses a non-standard protocol;
converting the reply message so as to conform with the protocol of the destination management interface, using the saved relationship information for the specific control instruction; and
forwarding the converted reply message to the destination management interface.

10. A method for managing a telecommunication node within an access network of central offices and customer premises equipment, comprising:
monitoring a control instruction received from a source one of a plurality of management interfaces, each management interface using a different protocol, the control instruction intended for controlling a destination one of at least one customer premises equipment (CPE), each CPE being controlled by a central office via a dedicated bi-directional data link;
when the control instruction is received from a management interface that uses a standard protocol, forwarding the control instruction to the destination CPE without conversion; and
when the control instruction is received from a management interface that does not use a standard protocol;
converting the control instruction so as to conform with a protocol of the data link between the central office and the destination CPE;
saving relationship information for the control instruction, the protocol of the source management interface, and the destination CPE;
requesting a logical bi-directional CPE management tunnel to carry the converted control instruction; and
forwarding the control instruction in the tunnel for further transmission to the destination CPE.

11. The method of claim 10 further comprising:
monitoring a reply message received from one of the CPEs in response to a specific control instruction, the reply message intended for a destination management interface;
when the destination management interface uses a standard protocol, forwarding the reply message to the destination management interface without conversion; and
when the destination management interface does not use a standard protocol;
converting the reply message so as to conform with the protocol of the destination management interface, using the saved relationship information for the specific control instruction;
requesting a logical bi-directional CPE management tunnel to carry the converted reply message; and
forwarding the converted reply message in the tunnel for further transmission to the destination management interface.
